(19) United States
(12) Patent Application Publication
(10) Pub. No.: US 2016/0307717 A1
(43) Pub. Date: Oct. 20, 2016

(54) POWER SUPPLY SYSTEM AND POWER BOARD

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: CHENG-JUN WANG, Wuhan (CN); MING-CHUAN LEE, New Taipei (TW); YONG-NIAN CHEN, Wuhan (CN); JIN-LAI LU, Wuhan (CN)

(21) Appl. No.: 14/698,448

(22) Filed: Apr. 28, 2015

(30) Foreign Application Priority Data
Apr. 16, 2015 (CN) 201510180315.3

(51) Int. Cl. H01H 47/00; G06F 3/041

(52) U.S. Cl. CPC H01H 47/00; G06F 3/041

(57) ABSTRACT

A power supply system includes a power board and a transmission cable. The power board provides a first voltage and a second voltage. The transmission cable transmits the first voltage to a first electronic element to activate the first electronic element to work, and transmit the second voltage to a second electronic element which has same function to the first electronic element to activate the second electronic element to work.

### CROSS-REFERENCE TO RELATED APPLICATIONS

This application claims priority to Chinese Patent Application No. 201510180315.3, filed on Apr. 16, 2015, the contents of which are incorporated by reference herein.

### FIELD

The subject matter herein relates to a power supply system and a power board.

### BACKGROUND

Some electronic elements, do not have a unified working voltage. For example the working voltage of some touch plates is 12V, and the working voltage of other touch plates is 5V. Thus, although different suppliers provide a same electronic element, the electronic element may have a different working voltage. Correspondingly, two different power boards may be provided to match with the two different work voltage electronic elements.

### BRIEF DESCRIPTION OF THE DRAWINGS

Implementations of the present technology will now be described, by way of example only, with reference to the attached figures.

FIG. 1 is a diagrammatic view of a power supply system providing a first working voltage.

FIG. 2 is a diagrammatic view of a power interface of the power supply system in FIG. 1.

FIG. 3 is similar to FIG. 1, but with the power supply system providing a second working voltage.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

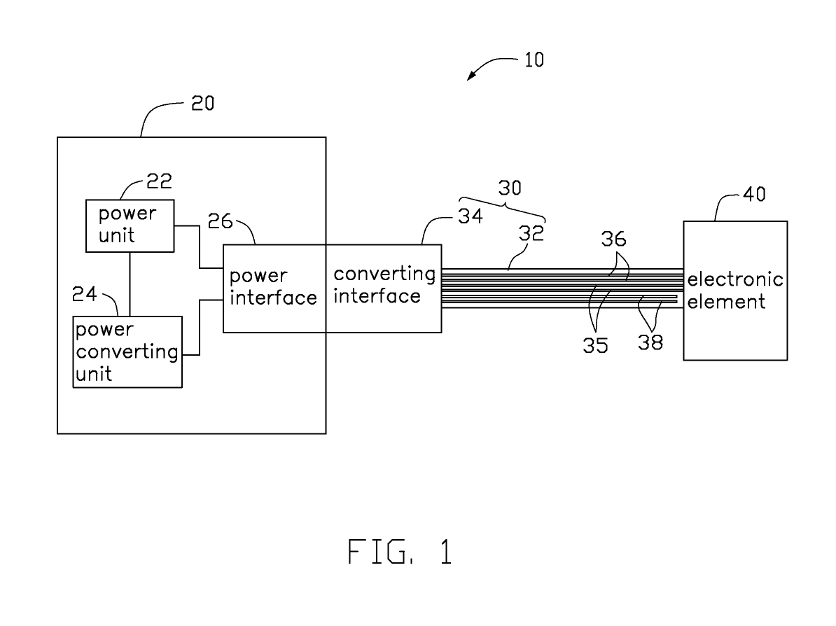

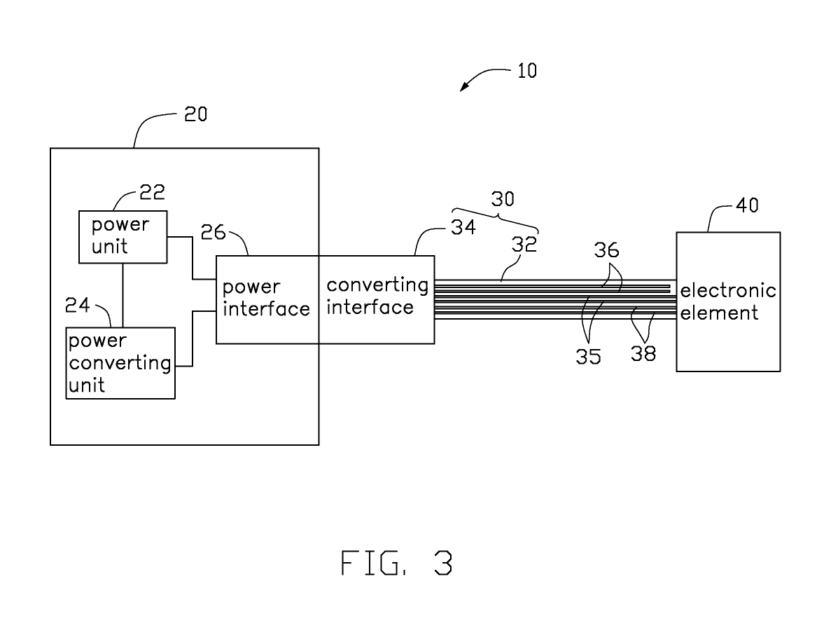

FIGS. 1 and 3 illustrate a power supply system 10 includes a power board 20, a transmission cable 30 and an electronic element 40. The working voltage of the electronic element 40 is a first working voltage or a second working voltage. The power board 20 is configured to provide a first voltage and a second voltage. The first voltage is equal to the first working voltage. The second voltage is equal to the second working voltage. The transmission cable 30 connects the power board 20 to the electronic element 40. The transmission cable 30 is configured to transmit the first voltage to the electronic element 40 when the working voltage of the electronic element 40 is the first working voltage and transmit the second voltage to the electronic element 40 when the working voltage of the electronic element 40 is the second working voltage.

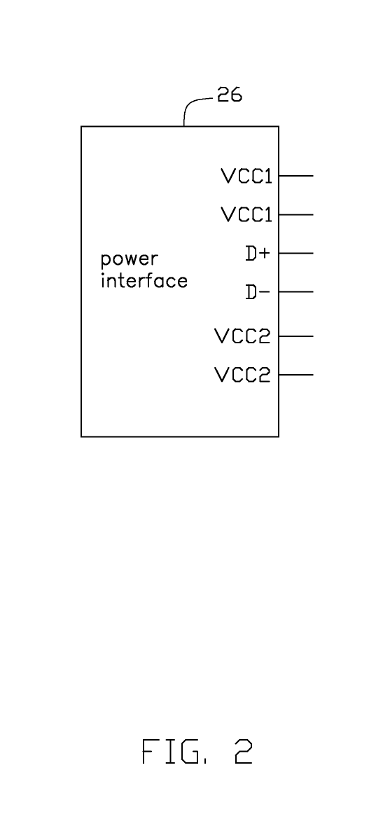

The power board 20 includes a power unit 22, a power converting unit 24 and a power interface 26. The transmission cable 30 includes a cable body 32 and a converting interface 34. The power unit 22 is configured to provide the first voltage. The power converting unit 24 electrically connects the power unit 22. The power converting unit 24 is configured to convert the first voltage to the second voltage. FIG. 2 illustrates the power interface 26 includes two first voltage input terminals VCC1 and two second voltage input terminals VCC2. The two first voltage input terminals VCC1 are configured to receive the first voltage from the power unit 22. The two second input terminals VCC2 are configured to receive the second voltage from the power converting unit 24. The power interface 26 further includes a data input terminal D+, a data out terminal D− and a number of grounded terminals (not shown).

The converting interface 34 includes a number of terminals corresponding to and connected to the number of terminals of the power interface 26. The cable body 32 includes two first wires 36 and two second wires 38. The two first wires 36 are connected to the first voltage input terminals VCC1 through the converting interface 34. The two first wires 36 are configured to transmit the first voltage to the electronic element 40 when the work voltage of the electronic element 40 is the first work voltage. The two second wires 36 are connected to the second voltage input terminals VCC2 through the converting interface 34. The two second wires 36 are configured to transmit the second voltage to the electronic element 40 when the working voltage of the electronic element 40 is the second working voltage. The cable body 32 further includes two data wires 35. The two data wires 35 are connected to the data input terminal D+ and the data out terminal D− through the converting interface 34. The two data wires 35 are configured to transmit data to the electronic element 40. The cable body 32 further includes a number of grounded wires (not shown).

In one embodiment, the electronic element 40 is a touch panel. The first working voltage is 12V. The second working voltage is 5V. The first voltage provided by the power unit 22 is 12V. The power converting unit 24 converts the 12V to 5V. When the working voltage of the electronic element 40 is 12V, the two first wires 36 are connected to the power port of the electronic element 40 to provide 12V to the electronic element 40. Thus, the electronic element 40 can work. When the working voltage of the electronic element 40 is 5V, the two second wires 38 are connected to the power port of the electronic element 40 to provide 5V to the electronic element 40. Thus, the electronic element 40 also can work.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A power supply system comprising:
an electronic element having a working voltage, which is either a first working voltage or a second working voltage;
a power board configured to provide a first voltage and a second voltage, wherein the first voltage is equal to the first working voltage, and the second voltage is equal to the second working voltage; and
a transmission cable connecting the power board to the electronic element and configured to transmit the first voltage to the electronic element when the working voltage of the electronic element is the first working voltage and transmit the second voltage to the electronic element when the working voltage of the electronic element is the second working voltage.

2. The power supply system as claimed in claim 1, wherein the power board comprises a power unit and a power converting unit, the power unit provides the first voltage, the power converting unit converts the first voltage to the second voltage.

3. The power supply system as claimed in claim 2, wherein the power board further comprises a power interface, the power interface connects the power unit and the power converting unit and receives the first voltage and the second voltage.

4. The power supply system as claimed in claim 3, wherein the power interface comprises two first voltage input terminals and two second voltage input terminals, the two first voltage input terminals receives the first voltage from the power unit, the two second input terminals receives the second voltage from the power converting unit.

5. The power supply system as claimed in claim 4, wherein the power interface further comprises a data input terminal and a data out terminal.

6. The power supply system as claimed in claim 4, wherein the transmission cable comprises two first wires and two second wires, the two first wires are connected to the first voltage input terminals, the two first wires are configured to transmit the first voltage to the electronic element when the working voltage of the electronic element is the first working voltage, the two second wires are connected to the second voltage input terminals, the two second wires are configured to transmit the second voltage to the electronic element when the working voltage of the electronic element is the second working voltage.

7. The power supply system as claimed in claim 1, wherein the first working voltage is 12V, the second working voltage is 5V.

8. The power supply system as claimed in claim 7, wherein the electronic element is a touch panel.

9. A power supply system comprising:
a power board configured to provide a first voltage and a second voltage; and
a transmission cable configured to transmit the first voltage to a first electronic element to activate the first electronic element to work, and transmit the second voltage to a second electronic element which has same function to the first electronic element to activate the second electronic element to work.

10. The power supply system as claimed in claim 9, wherein the power board comprises a power unit and a power converting unit, the power unit provides the first voltage, the power converting unit converts the first voltage to the second voltage.

11. The power supply system as claimed in claim 10, wherein the power board further comprises a power interface, the power interface connects the power unit and the power converting unit and receives the first voltage and the second voltage.

12. The power supply system as claimed in claim 11, wherein the power interface comprises two first voltage input terminals and two second voltage input terminals, the two first voltage input terminals receives the first voltage from the power unit, the two second input terminals receives the second voltage from the power converting unit.

13. The power supply system as claimed in claim 12, wherein the power interface further comprises a data input terminal and a data out terminal.

14. The power supply system as claimed in claim 11, wherein the transmission cable comprises two first wires and two second wires, the two first wires are connected to the first voltage input terminals, the two first wires are configured to transmit the first voltage to the electronic element when the working voltage of the electronic element is the first working voltage, the two second wires are connected to the second voltage input terminals, the two second wires are configured to transmit the second voltage to the electronic element when the working voltage of the electronic element is the second working voltage.

15. The power supply system as claimed in claim 9, wherein the first voltage is 12V, the second voltage is 5V.

16. The power supply system as claimed in claim 15, wherein the electronic element is a touch panel.

17. A power board comprising:
a power unit configured to provides a first voltage;
a power converting unit configured to convert the first voltage to a second voltage; and
a power interface configured to transmit the first voltage to a first electronic element to activate the first electronic element to work, and transmit the second voltage to a second electronic element which has same function to the first electronic element to activate the second electronic element to work.

18. The power board as claimed in claim 17, wherein the power interface comprises two first voltage input terminals and two second voltage input terminals, the two first voltage input terminals receives the first voltage from the power unit, the two second input terminals receives the second voltage from the power converting unit.

19. The power board as claimed in claim 18, wherein the power interface further comprises a data input terminal and a data out terminal.

20. The power board as claimed in claim 17, wherein the first voltage is 12V, the second voltage is 5V.
